(19) United States
(12) Patent Application Publication
(10) Pub. No.: US 2008/0061642 A1
(43) Pub. Date: Mar. 13, 2008

(54) Output terminal structure of alternator for vehicle

(75) Inventors: Akihito Koike, Kariya-shi (JP); Yoshiki Tan, Anjo-shi (JP); Masatoshi Koumura, Okazaki-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/892,543

(22) Filed: Aug. 23, 2007

(30) Foreign Application Priority Data
Sep. 7, 2006 (JP) 2006-242712

(51) Int. Cl. H02K 19/36

(52) U.S. Cl. 310/71; 310/68 D

(57) ABSTRACT

An alternator for a vehicle is provided which is equipped with a rectifier. The rectifier includes a positive-side radiator fin in which a positive rectifying device is installed. An output terminal through which dc voltage is outputted has a rectangular head and is fit in a through hole formed in the positive-side radiator fin. Ribs are formed on the positive-side radiator fin across the through hole. The rectangular head of the output terminal is shaped to have two sides and a diagonal line. The diagonal line is longer than an interval between the ribs. The sides are located at a distance away from each other which is smaller than the interval between the ribs. Specifically, the ribs serve as stoppers on which corners of the head hits when excessive torque acts on the output terminal, thereby minimizing deformation of the positive-side radiator fin and undesirable rotation of the output terminal.

### CROSS REFERENCE TO RELATED DOCUMENT

The present application claims the benefit of Japanese Patent Application No. 2006-242712 filed on Sep. 7, 2006, the disclosure of which is incorporated herein by reference.

### BACKGROUND OF THE INVENTION

1. Technical Field of the Invention

The present invention relates generally to an alternator which may be installed in passenger automobiles or autotrucks, and more particularly to such an alternator designed to have a structure improved to avoid deformation of a radiator fin of a rectifier and undesirable rotation of an output terminal, and ensure the stability of electric connection between the output terminal and a harness of a vehicle.

2. Background Art

Typical automotive alternators are equipped with a rectifier which has a positive-side radiator fin and a negative-side radiator fin which extend perpendicular to a rotating shaft in order to decrease an axial length of the alternator and increase areas of the radiator fins from which heat dissipates. For example, Japanese Patent First Publication No. 2002-300756 corresponding to U.S. Pat. No. 6,958,557 B2, assigned to the same assignee as that of this application, discloses such a type of alternator equipped with the positive-side and negative-side radiator fins. The radiator fins are each formed by stamping a plate using a press and bending it. An output terminal is fit in the positive-side radiator fin so that it extends radially thereof. The output terminal has a head placed in abutment with the surface of the positive-side radiator fin. The head is of a polygonal shape in order to hold a body of the output terminal from rotating when a harness of the vehicle is connected to or disconnected from the output terminal by fastening or unfastening a nut.

The above alternator, however, has the drawback in that installation of the output terminal in the positive-side radiator fin requires a high degree of accuracy in positioning thereof, thus resulting in an increase in production steps. Specifically, the positive-side radiator fin is bent into an L-shape to have two surfaces extending perpendicular to each other. One of the surfaces has the hole in which the output terminal is to be fit. In order to keep the corner of the polygonal head of the output terminal away from the other surfaces of the positive-side radiator fin through a small gap during installation of the output terminal, it is necessary to locate the hole in the positive-side radiator fin and machine the head with high accuracy and regulate the orientation of the head when the output terminal is fitted in the hole. When the torque acts on the output terminal, it will cause the corner of the head to hit the surface of the positive-side radiator fin to stop the output terminal from rotating undesirably. Thus, when an output conductor of the vehicle is joined or fastened to the output terminal, it will cause mechanical stress to concentrate on a portion of the head of the output terminal, which may result in deformation of the radiator fin. The excessive deformation of the radiator fin may permit the output terminal to rotating undesirably.

### SUMMARY OF THE INVENTION

It is therefore a principal object of the invention to avoid the disadvantages of the prior art.

It is another object of the invention to provide an alternator for vehicles which has a structure improved to avoid deformation of a radiator fin of a rectifier and undesirable rotation of an output terminal and ensure the stability of electric connection between the output terminal and a harness of a vehicle.

According to one aspect of the invention, there is provided an alternator which may be employed in automotive vehicles. The alternator comprises: (a) a stator winding; (b) a rotor working to rotate to induce ac voltage at the stator winding; (c) a rectifier including a positive rectifying device and a negative rectifying device to rectify the ac voltage, as induced at the stator winding, into dc voltage; (d) a frame on which the rectifier is installed; (e) a positive-side radiator fin in which the positive rectifying device is installed, the positive-side radiator fin having a through hole; (f) an output terminal through which the dc voltage, as produced by the rectifier, is outputted, the output terminal having a head and being fit in the through hole of the positive-side radiator fin in abutment of the head with an outer surface of the positive-side radiator fin; and (g) a first and a second protrusion formed on the positive-side radiator fin across the through hole. The first and second protrusions have a first and second surface, respectively, which face each other over the through hole at a given interval and extend substantially parallel to each other. The head of the output terminal is shaped to have a first and a second sides and a diagonal line. The diagonal line is longer than the interval between the first and second protrusions. The first and second sides are located at a distance away from each other which is smaller than the interval between the first and second protrusions.

When a conductor such as a harness of the vehicle is joined to or removed from the output terminal, for example, by fastening or loosening a nut to or from the output terminal, so that excessive torque acts on the output terminal, the first and second protrusions serve as stoppers on which two corners of the head hit to hold the output terminal from rotating undesirably. The hitting of the two corners on the protrusions results in distribution of stress over the head, thereby minimizing the deformation of the positive-side radiator fin.

In the preferred mode of the invention, the positive-side radiator fin has a first wall on which the positive rectifying device is installed and a second wall in which the through hole is formed. The second wall is oriented perpendicular to the first wall. The first and second protrusions are ribs extending perpendicular to both the first and second walls.

Specifically, the second wall extends perpendicular to the first wall on which the positive rectifying device is installed. The protrusions extend between the first and second protrusions, thus resulting in an increase in rigidity of the positive-side radiator fin which increases the resistance to the deformation thereof.

A least one of the ribs is shaped to have an end contoured by a plurality of curves, thereby distributing the stress acting on the rib to minimize the deformation of the positive-side radiator fin further.

The head of the output terminal is of a rectangular shape, thereby facilitating ease with which the sides of the head are increased in length, thus enhancing the function of the protrusions as the stoppers to hold the head from rotating.

The positive-side radiator fin is made by die-casting aluminum, thus facilitating the formation of the protrusions into a desired shape.

The alternator may further include a terminal table in which connector terminals are embedded in electric connections with the positive and negative rectifying devices of the rectifier.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partially longitudinal sectional view which shows the structure of an alternator according to the invention;

FIG. 2 is a plane view which shows a positive-side radiator fin installed in the alternator of FIG. 1;

FIG. 3 is a sectional view, as taken along the line III-III in FIG. 2, from which an output terminal is omitted; and

FIG. 4 is a partial view which illustrates the positive-side radiator fin, as viewed from a P direction in FIG. 2.

### DESCRIPTION OF THE PREFERRED EMBODIMENTS

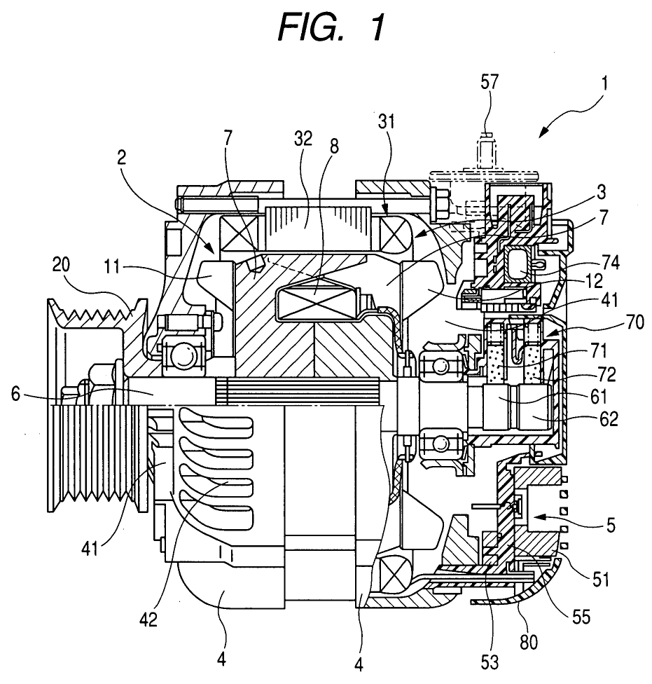

Referring to the drawings, wherein like reference numbers refer to like parts in several views, particularly to FIG. 1, there is shown an AC generator or alternator 1 for automotive vehicles according to the first embodiment of the invention.

The alternator 1 consists essentially of a rotor 2, a stator 3, a frame assembly 4, and a rectifier 5.

The rotor 2 is, as clearly shown in FIG. 1, made up of a pair of Randel-type pole cores 7 with claws and a field coil 8 retained between the pole cores 7. The field coil 8 is made of copper wire which is coated with an insulator and wound coaxially in the form of a cylindrical shape. A rotating shaft 6 is inserted through the pole cores 7. A cooling fan 11 is welded to an end wall of a front one (i.e., a left one, as viewed in FIG. 1) of the pole cores 7. The cooling fan 11 works to suck air from the front of the alternator 1 and discharge it axially and radially of the alternator 1. Similarly, a centrifugal fan 12 is welded to an end wall of a rear one of the pole cores 7 and works to suck air from the rear of the alternator 1 and discharge it radially of the alternator 1. Slip rings 61 and 62 are formed on a rear end portion of the rotating shaft 6 and placed in electrical connection with ends of the field coil 8. The alternator 1 also includes a brush unit 70 which works to feed electric power to the field coil 8 through the slip rings 61 and 62. The stator 3 includes a stator core 32 and a stator winding 31.

The frame assembly 4 retains the rotor 2 and the stator 3 therein. Specifically, the rotor 2 is supported to be rotatable about the rotating shaft 6. The stator 3 is placed around the outer periphery of the pole cores 7 through a given gap. The frame assembly 4 has cooling air outlets 42 formed in portions thereof facing the ends (also called coil ends) of the stator winding 31 of the stator 3. The frame assembly 4 also has cooling air inlets 41 formed in the ends thereof opposed to each other in the axial direction of the alternator 1.

The rectifier 5 works to rectify three-phase ac voltage, as outputted from the three-phase stator winding 31 to produce dc voltage. The rectifier 5 is equipped with a positive-side radiator fin (also called a heat sink) 51 on which positive rectifying devices are mounted, a negative-side radiator fin 53 on which negative rectifying devices are mounted, a terminal board 55 in which connector terminals are embedded to establish electrical connections between the positive and negative rectifying devices, and an output terminal (i.e., a positive terminal) 57 fitted in a hole extending through the positive radiator fin 51. The structure of the positive radiator fin 51 near the output terminal 57 will be described later in detail.

The brush unit 70 works to supply excitation current to the field coil 8 of the rotor 2 through the rectifier 5 and is equipped with brushes 71 and 72 which are biased elastically against the slip rings 61 and 62 on the rotating shaft 6 of the rotor 2, respectively. The frame assembly 4 is made of a front and a rear frame. The brush unit 70, the rectifier 5, and an IC regulator 74 are installed on the rear frame. A rear cover 80 is secured to the rear frame to cover the brush unit 70, the rectifier 5, the IC regulator 74, etc. to protect them physically.

In operation of the alternator 1, when the torque is transmitted from the engine (not shown) to the pulley 20 through a belt (not shown), it will cause the rotor 2 to rotate in a given direction. Application of excitation voltage to the field coil 8 of the rotor 2 will cause the claws of the pole cores 7 to be excited to develop three-phase ac voltage at the stator windings 31. The rectifier 5 then outputs dc power from the output terminal 57.

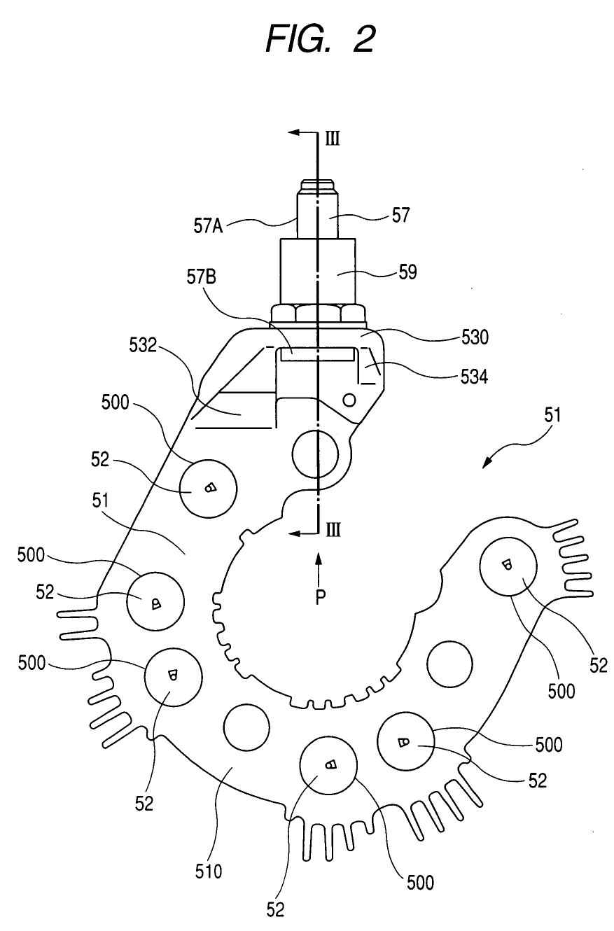

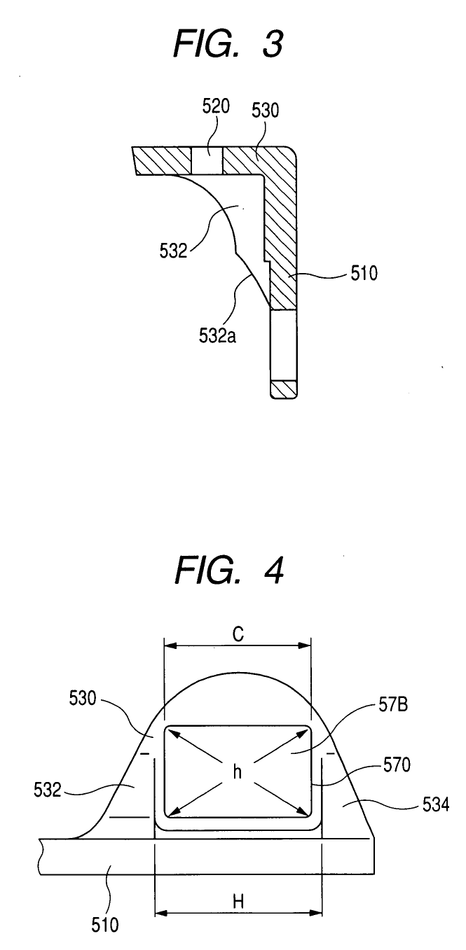

The structure of the rectifier 5, especially the positive-side radiator fin 51 and the output terminal 57 installed thereon will be described below in detail. FIG. 2 is a plane view which illustrates the positive-side radiator fin 51 of the rectifier 5. FIG. 3 is a sectional view, as taken along the line III-III in FIG. 2, from which the output terminal 57 is omitted. FIG. 4 is a partial view which illustrates the positive-side radiator fin 51, as viewed from a P direction in FIG. 2.

The positive-side radiator fin 51 has a first wall 510 having formed therein six through holes 500 in which the six rectifying devices 52 are fit, respectively, and a second wall 530 having formed therein a through hole 520 in which the output terminal 57 is fit. After the rectifier 5 is installed in the alternator 1, the first wall 510 is oriented perpendicular to the rotating shaft 6, while the second wall 530 is oriented perpendicular to the first wall 510.

The positive-side radiator fin 51 also has ribs 532 and 534 formed on both sides of the through hole 520 in which the output terminal 57 is fit. The ribs 532 and 534 has inner walls which are opposed and extend parallel to each other. The ribs 532 and 534 are oriented parallel to both the first and second walls 510 and 530 and formed integrally with the first and second walls 510 and 530. The rib 532 is greater in size or area than the rib 534 and has an end wall 532a whose profile is, as can be seen in FIG. 3, defined by a plurality of curved lines (i.e., two curves in this embodiment). The area of the rib 532 which is greater than that of the rib 534 is determined depending upon the positional relation therebetween, as illustrated in FIG. 2, and may alternatively be designed to be identical with or smaller than that of the rib 534 in the case where the positional relation or structure of the ribs 532 and 534 is different from the one in FIG. 2. The positive-side and negative-side radiator fins 51 and 53 are made by, for example, die-casting aluminum. Only the positive-side radiator fin 51 may be made using such die casting techniques.

The terminal 57 is shaped like a rectangular headed bolt and is made up of a rectangular head 57B and a shank or shaft 57A extending from the head 57B perpendicular thereto. The shaft 57A is formed by a cylindrical bar made up of a threaded portion and a non-threaded portion which continues to the surface of the head 57B. The non-threaded portion may be knurled. The non-threaded portion has an outer diameter which is slightly greater than an inner diameter of the through hole 520 so that it may be press-fit in the through hole 520. The installation of the terminal 57 to the positive-side radiator fin 51 is achieved by inserting the shaft 57A through the hole 520 from between the ribs 532 and 534 until the non-threaded portion is press-fit in the hole 520, and the head 57B hits the surface of the second wall 530, as illustrated in FIG. 2. Subsequently, a nut 95 with a flange is screwed on the threaded portion of the shaft 57A tightly from the side opposite the head 57B to nip the second wall 530 between the flange of the nut 95 and the head 57B of the output terminal 57.

The head 57B of the output terminal 57 is of a rectangular shape, viewed from the direction P in FIG. 2. Specifically, the head 57B is, as can be seen from FIG. 4, made of a rectangular plate whose diagonals h are longer than a minimum interval H between the opposed surfaces of the ribs 532 and 534 and which has two sides 570 extending parallel to each other at a distance c away from each other. The distance c is smaller than the interval H. The ribs 532 and 534 serve as a guide for guiding the insertion of the output terminal 57 into the hole 520.

The parallelism between the ribs 532 and 534 may lie within a tolerance of 2° 30′ that is an angle which the opposed inner walls of the ribs 532 and 534 make with each other. The same applies to the parallelism between the sides 570 of the head 57B of the output terminal 57.

As apparent from the above discussion, when excessive torque acts on the output terminal 57, so that it turns, the ribs 532 and 534 serves as stoppers on which corners of the head 57B hit to hold the head 57B from rotating, thereby avoiding the local concentration of stress at the head 57B of the output terminal 57 to minimize the deformation of the positive-side radiator fin 57 of the rectifier 5. The second wall 530 which is formed perpendicular to the first wall 510 in which the positive rectifying devices 52 and the ribs 532 and 534 which are formed between the first and second walls 510 and 530 enhance the rigidity of the positive-side radiator fin 51, thus minimizing the deformation thereof further.

The rib 532, as described above with reference to FIG. 3, has the end wall 532a having the outline defined by two curves, thereby distributing the stress acting on the rib 532 to minimize the deformation of the positive-side radiator fin 51 further. The rectangular shape of the head 57B of the output terminal 57 facilitates ease with which the sides 570 of the head 57B facing the inner walls of the ribs 532 and 534 are increased in length, thus enhancing the function of the ribs 532 and 534 as the stoppers to hold the head 57B from rotating. The positive-side radiator fin 51 is, as described above, made by die-casting aluminum, thus facilitating the formation of the ribs 532 and 534 into a desired shape.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims. For example, the head 57B of the output terminal 57 may be shaped to have at least one of two opposed sides adjacent the sides 570 which is curved or to be polygonal other than rectangular as long as the diagonals h are longer than the interval H.

The output terminal 57 which is fit in the second wall 530 of the positive-side radiator fin 51 extends radially of the rotating shaft 6 (i.e., perpendicular to the rotating shaft 6), but however, may alternatively be oriented parallel to the rotating shaft 6. This may be achieved by orienting the second wall 530 of the positive-side radiator fin 51 parallel to the first wall 510, that is, forming the second wall 530 to lie flush with the first wall 510 or by forming a portion of the first wall 510 to have the same structure as the second wall 530.

What is claimed is:

1. An alternator for a vehicle comprising:
a stator winding;
a rotor working to rotate to induce ac voltage at said stator winding;
a rectifier including a positive rectifying device and a negative rectifying device to rectify the ac voltage, as induced at said stator winding, into dc voltage;
a frame on which said rectifier is installed;
a positive-side radiator fin in which the positive rectifying device is installed, said positive-side radiator fin having a through hole;
an output terminal through which the dc voltage, as produced by said rectifier, is outputted, said output terminal having a head and being fit in the through hole of said positive-side radiator fin in abutment of the head with an outer surface of said positive-side radiator fin; and
a first and a second protrusion formed on said positive-side radiator fin across the through hole, the first and second protrusions having a first and second surface, respectively, which face each other over the through hole at a given interval and extend substantially parallel to each other,
wherein the head of said output terminal is shaped to have a first and a second sides and a diagonal line, the diagonal line being longer than the interval between said first and second protrusions, the first and second sides being located at a distance away from each other which is smaller than the interval between said first and second protrusions.

2. An alternator as set forth in claim 1, wherein said positive-side radiator fin has a first wall on which the positive rectifying device is installed and a second wall in which the through hole is formed, the second wall being oriented perpendicular to the first wall, and wherein said first and second protrusions are ribs extending perpendicular to both the first and second walls.

3. An alternator as set forth in claim 2, wherein at least one of the ribs is shaped to have an end contoured by a plurality of curves.

4. An alternator as set forth in claim 1, wherein the head of said output terminal is of a rectangular shape.

5. An alternator as set forth in claim 1, wherein said positive-side radiator fin is made by casting.

6. An alternator as set forth in claim 5, wherein said positive-side radiator fin is made by die-casting aluminum.

7. An alternator as set forth in claim 1, further comprising a terminal table in which connector terminals are embedded in electric connections with the positive and negative rectifying devices of said rectifier.
